(19) United States
(12) Patent Application Publication
(10) Pub. No.: US 2010/0052617 A1
(43) Pub. Date: Mar. 4, 2010

(54) Degradation determination method for lithium-ion battery, control method for lithium-ion battery, degradation determination apparatus for lithium-ion battery, control apparatus for lithium-ion battery, and vehicle

(75) Inventors: Koji Aridome, Toyota-shi (JP); Junichi Matsumoto, Toyota-shi (JP); Daisuke Kuroda, Kariya-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/585,080

(22) Filed: Sep. 2, 2009

(30) Foreign Application Priority Data
Sep. 3, 2008 (JP) 2008-225691

(51) Int. Cl. H02J 7/00

(52) U.S. Cl. 320/132

(57) ABSTRACT

A degradation state of a lithium-ion battery is determined on the basis of information about a voltage change in the lithium-ion battery obtained in a diagnosis mode in which the lithium-ion battery is successively charged and discharged at a constant power value. The constant power value in the diagnosis mode preferably may vary with the power storage amount and the temperature of the lithium-ion battery. As the information, the degree of a voltage drop in the lithium-ion battery obtained during the discharge can be used.

### TECHNICAL FIELD

The present invention relates to a method of determining the degradation state of a lithium-ion battery, a control method for controlling the lithium-ion battery based on the determination results obtained in the determination method, and the like.

### BACKGROUND ART

Power storage apparatuses such as lithium-ion batteries are known as driving or auxiliary power sources for electric vehicles and hybrid vehicles. It is known that repeated charge and discharge of the power storage apparatus increases its internal resistance to cause degradation thereof.

Patent Document 1 discloses a method of calculating the degradation of the capacity of a secondary battery based on a ratio between the slope of an open-circuit voltage versus discharge current amount characteristic at initial stages of the battery and the slope of an open-circuit voltage versus discharge current amount characteristic at stages of the battery after degradation. Patent Document 2 discloses a control apparatus for a battery module, including the battery module formed of a plurality of stacked cells and mounted on a vehicle, a voltage detecting section for detecting the voltage of the battery module, and a control section for controlling charge and discharge of the battery module such that the battery module is charged when the voltage of the battery module drops to the lower limit of voltage values at which the battery module can be controlled. Upon sensing start of the vehicle, the control section discharges the battery module until the voltage detected by the voltage detecting section reaches the lower limit.

According to the control apparatus for the battery module structured as above, the battery module is intentionally discharged after the start of the vehicle, thereby quickly bringing the voltage of the battery module to the level at which the battery module is switched from discharge to charge. Thus, if a temperature difference is present between the cells, it is possible to avoid a long continuation of a significant voltage drop in one of the cells where the temperature is lower. This can prevent degradation of the cells.

[Patent Document 1] Japanese Patent Laid-Open No. 2000-261901

[Patent Document 2] Japanese Patent Laid-Open No. 2007-181291

[Patent Document 3] Japanese Patent Laid-Open No. 2007-113953

[Patent Document 4] Japanese Patent Laid-Open No. 2003-243042

When the lithium-ion battery is degraded and thus predetermined output characteristics are not satisfied, the battery needs replacement. For this reason, the degradation of the lithium-ion battery needs to be sensed immediately. However, the lithium-ion battery is degraded due to various factors (for example, repeated charge and discharge), and it is not easy to determine all of the causes accurately. It is thus a first object of the present invention to sense the degradation state of the lithium-ion battery. It is a second object thereof to suppress the degradation of the lithium-ion battery.

### SUMMARY

To solve the abovementioned problems, the present invention provides a degradation determination method for a lithium-ion battery. In the degradation determination method, a degradation state of the lithium-ion battery is determined based on information about a voltage change in the lithium-ion battery obtained in a diagnosis mode. In the diagnosis mode, the lithium-ion battery is successively charged and discharged at a constant power value.

The constant power value in the diagnosis mode may vary with a power storage amount and a temperature of the lithium-ion battery.

Serving as the information, the degree of a voltage drop in the lithium-ion battery obtained during the discharge can be used.

According to a control method for a lithium-ion battery, the degradation determination method is performed. In addition, an upper limit value of electric current is changed in lowering direction, when it is determined that the degree of the voltage drop is equal to or more than a threshold value in the degradation determination method. The upper limit value is set as a maximum value of electric current output from the lithium-ion battery. This can suppress a voltage drop during the discharge to prevent degradation of the lithium-ion battery.

Serving as the information, the degree of a voltage increase in the lithium-ion battery obtained during the charge can be used.

According to a control method for a lithium-ion battery, the degradation determination method is performed. In addition, an upper limit value of electric current is changed in lowering direction, when it is determined that the degree of the voltage increase is equal to or more than a threshold value in the degradation determination method. The upper limit value is set as a maximum value of electric current input to the lithium-ion battery. This can suppress a voltage increase during the charge to prevent degradation of the lithium-ion battery.

A degradation determination apparatus for a lithium-ion battery, determining a degradation state of the lithium-ion battery, comprises an obtaining section which obtains information about a voltage of the lithium-ion battery, and a determining section which determines the degradation state of the lithium-ion battery based on the information obtained by the obtaining section in a diagnosis mode. In the diagnosis mode, the lithium-ion battery is successively charged and discharged at a constant power value.

The constant power value in the diagnosis mode may vary with a power storage amount and a temperature of the lithium-ion battery.

Serving as the information, the degree of a voltage drop in the lithium-ion battery obtained during the discharge can be used.

A control apparatus of a lithium-ion battery comprises the degradation determination apparatus described above and an electric-current control section. The electric-current control section changes an upper limit value of electric current in lowering direction when the determining section determines that the degree of the voltage drop is equal to or more than a threshold value. The upper limit value is set as a maximum value of electric current output from the lithium-ion battery.

Serving as the information, the degree of a voltage increase in the lithium-ion battery obtained during the charge can be used.

A control apparatus of a lithium-ion battery comprises the degradation determination apparatus and an electric-current control section. The electric-current control section changes an upper limit value of electric current in lowering direction when the determining section determines that the degree of the voltage increase is equal to or more than a threshold value. The upper limit value is set as a maximum value of electric current input to the lithium-ion battery.

The control apparatus of a lithium-ion battery described above can be mounted on a vehicle such as an electric vehicle, a hybrid vehicle, and a fuel-cell vehicle.

According to the present invention, the degradation state of the lithium-ion battery can be sensed.

### DESCRIPTION OF DRAWINGS

FIG. 1 is a block diagram showing a determination system for determining high-rate degradation of a lithium-ion battery.

FIG. 2 shows diagrams schematically showing the characteristics when the high-rate degraded lithium-ion battery is discharged, in which (A) shows battery output values and (B) shows battery voltage values.

FIG. 3 shows diagrams schematically showing the characteristics when the high-rate degraded lithium-ion battery is charged, in which (A) shows battery input values and (B) shows battery voltage values.

FIG. 4 shows electrical characteristics of the lithium-ion battery when a diagnosis mode is performed, in which (A) is a power characteristic diagram and (B) is a voltage characteristic diagram.

FIG. 5 shows electrical characteristics of the lithium-ion battery when the diagnosis mode is performed, in which (A) is a power characteristic diagram and (B) is a voltage characteristic diagram.

FIG. 6A is a flow chart showing the processing procedure of the diagnosis mode.

FIG. 6B is a flow chart showing the processing procedure of the diagnosis mode.

### DETAILED DESCRIPTION

Embodiments of the present invention will hereinafter be described.

First circumstances under which the present invention has been made are described.

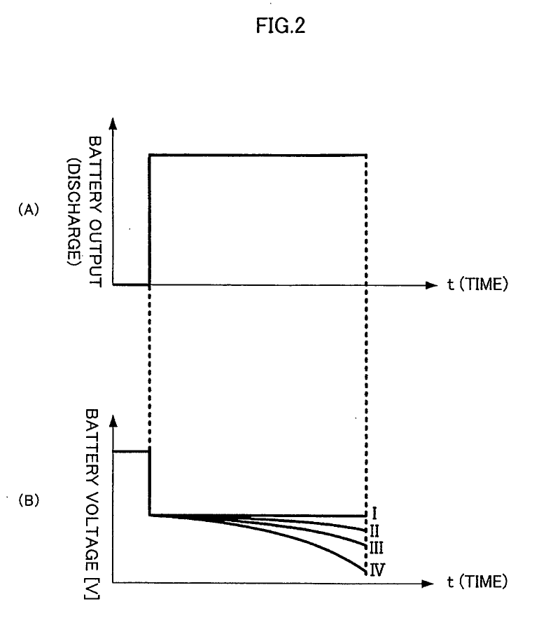

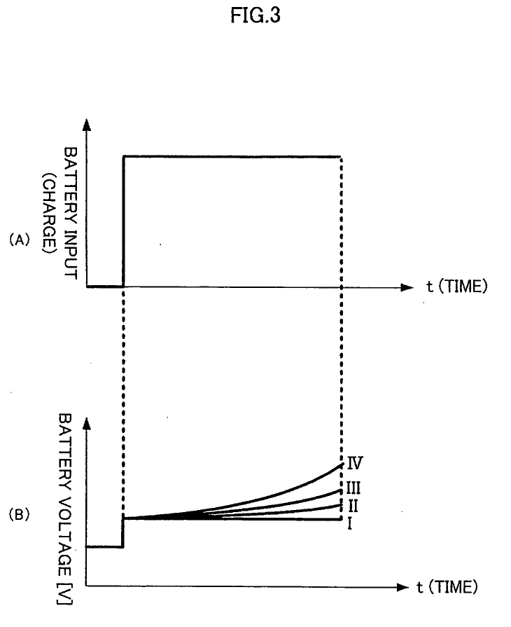

The present inventors have found occurrence of a high-rate degradation phenomenon in a lithium-ion battery. The high-rate degradation phenomenon will be described with reference to FIGS. 2 and 3. FIG. 2 shows graphs schematically showing electric characteristics when a high-rate degraded lithium-ion battery is discharged, in which (A) shows battery output values and (B) shows battery voltage values. FIG. 3 shows graphs schematically showing electric characteristics when a high-rate degraded lithium-ion battery is charged, in which (A) shows battery input values and (B) shows battery voltage values. As shown in FIGS. 2 and 3, the lithium-ion battery has constant power values at input and output.

When discharge operation in which the lithium-ion battery is discharged at a high output value (power) over a predetermined time period or charge operation in which the lithium-ion battery is charged at a high input value (power) over a predetermined time period is repeatedly performed, a phenomenon (that is, a high-rate degradation phenomenon) occurs in which the voltage of the lithium-ion battery decreases or increase during the discharge operation or the charge operation due to a phenomenon in which the internal resistance increases.

For example, in a hybrid vehicle which employs both of an internal-combustion engine and a motor as a power source, the high-rate degradation phenomenon may occur from repeated high-speed running which involves extremely high outputs of the lithium-ion battery serving as the driving source of the motor and the internal-combustion engine.

In FIG. 2, a curve I represents the voltage value of the lithium-ion battery before the battery reaches the high-rate degradation. Curves II to IV represent the changes of the voltage of the lithium-ion battery after the battery reaches the high-rate degradation. As shown by the curve I, even when the lithium-ion battery before the high-rate degradation is discharged at the constant output value over a predetermined time period, the voltage value of the lithium-ion battery remains constant without any change.

On the other hand, when the lithium-ion battery is discharged at the constant output over the predetermined time period after the battery reaches the high-rate degradation, the voltage value of the lithium-ion battery gradually decreases over time as shown by the curves II to IV in FIG. 2. The curve III represents the state where the high-rate degradation is in a more advanced stage than in the curve II, and the curve IV represents the state where the high-rate degradation is in a more advanced stage than in the curve III. It can be seen from those results that as the lithium-ion battery is degraded to a more significant extent, a larger voltage drop amount is found in discharge.

Thus, the lithium-ion battery can be appropriately protected by discharging the high-rate degraded lithium-ion battery at such a constant power value as to cause a voltage drop and setting a diagnosis mode in which the degree of the voltage drop during the discharge is examined.

In FIG. 3, a curve I represents the voltage of the lithium-ion battery before the battery reaches the high-rate degradation. Curves II to IV represent the changes of the voltage of the lithium-ion battery after the battery reaches the high-rate degradation. Even when the lithium-ion battery before the high-rate degradation is charged at the constant input over a predetermined time period, the voltage value of the lithium-ion battery remains constant without any change as shown by the curve I.

On the other hand, when the lithium-ion battery is charged at the constant input over the predetermined time period after the battery reaches the high-rate degradation, the voltage value of the lithium-ion battery gradually increases over time as shown by the curves II to IV in FIG. 3. The curve III represents the state where the high-rate degradation is in a more advanced stage than in the curve II, and the curve IV represents the state where the high-rate degradation is in a more advanced stage than in the curve III. It can be seen from those results that as the lithium-ion battery is degraded to a more significant extent, a larger voltage increase amount is found in charge.

Thus, the lithium-ion battery can be appropriately protected by charging the high-rate degraded lithium-ion battery at such a constant power value as to cause a voltage increase and setting a diagnosis mode in which the degree of the voltage increase during the charge is examined.

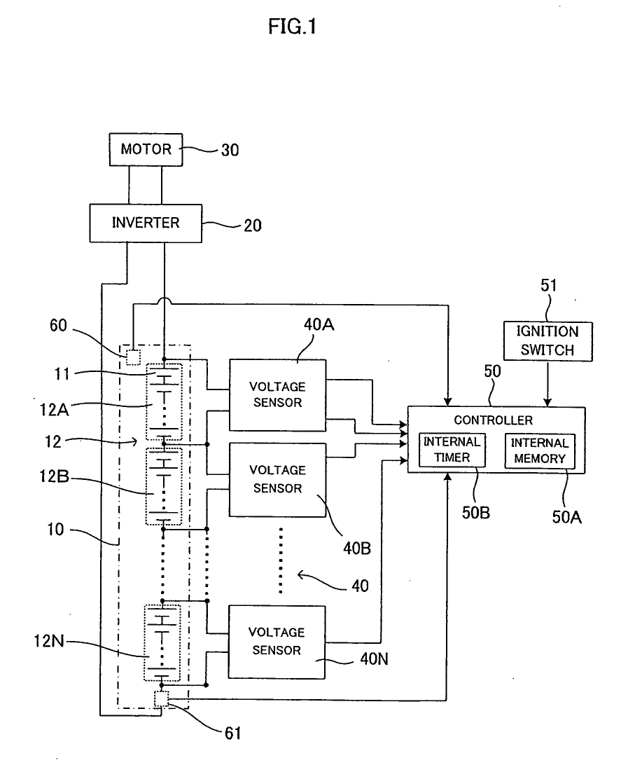

FIG. 1 is a block diagram showing a determination system for effectively performing a determination method of determining whether the lithium-ion battery reaches the high-rate degradation. In FIG. 1, an assembled battery (power storage apparatus) 10 is formed of a Plurality of battery blocks 12 electrically connected in serial. In the embodiment, 14 battery blocks 12A to 12N are connected in series. The battery blocks 12A to 12N are arranged in this order. Each of the battery blocks 12A to 12N is formed of a plurality of cells 11.

The cells 11 are connected electrically in series. The numbers of the cells 11 included in each of the battery blocks 12A to 12N are the same and set to 12 in the embodiment. The numbers of the battery blocks 12 and the cells 11 may be changed as appropriate depending on the intended use of the assembled battery 10.

An inverter 20 is electrically connected via wiring to a general positive terminal and a general negative terminal of the assembled battery 10. The inverter 20 is electrically connected to a motor 30 which is driven with the output from the assembled battery 10.

The assembled battery 10 of the embodiment is mounted on a vehicle (not shown) which can be run by driving the motor 30. During braking of the vehicle, the assembled battery 10 can be charged with power generated by a motor generator (not shown) serving as an electric power generator.

Examples of the abovementioned vehicle include hybrid vehicles and electric vehicles. The hybrid vehicle refers to a vehicle which is equipped not only with the assembled battery 10 but also with another power source such as an internal-combustion engine and a fuel cell for running the vehicle. The electric vehicle refers to a vehicle which runs only with the output from the assembled battery 10.

The cells 11 forming the assembled battery 10 are lithium-ion batteries. A composite oxide of lithium and transition metal can be used as an active material of a positive electrode layer forming part of the lithium-ion battery, while carbon can be used as an active material of a negative electrode layer. As a conductive agent, it is possible to acetylene black, carbon black, graphite, carbon fiber, and carbon nanotube.

A temperature sensor (for example, thermistor) 60 is provided in the assembled battery 10. The temperature sensor 60 is electrically connected to a controller (corresponding to determination section or electric-current control section cited in the claimed invention) 50. The controller 50 always monitors the temperature of the assembled battery 10 based on temperature information output from the temperature sensor 60.

An electric-current sensor 61 is connected to the wiring of the assembled battery 10. The electric-current sensor 61 is electrically connected to the controller 50. The controller 50 performs monitoring such that the electric-current value of the assembled battery 10 does not exceed a preset upper limit value of electric current based on electric-current information output from the electric-current sensor 61. In other words, the controller 50 performs monitoring such that the value of the electric current of the assembled battery 10 flowing during charge and discharge does not exceed the upper limit value of electric current.

Voltage sensors 40A to 40N are electrically connected to the battery blocks 12A to 12N, respectively. The voltage sensors 40A to 40N detect the voltages of the associated battery blocks 12A to 12N (hereinafter referred to as block voltages) and output the detection results to the controller 50. The controller 50 is electrically connected to an ignition switch 51.

The controller 50 has an internal memory 50A. A RAM (random access memory), a ROM (read only memory) or the like can be used as the internal memory 50A. The internal memory 50A has, for example, a threshold value (later described) stored therein for evaluating a voltage drop amount or a voltage increase amount. The memory 50A may be provided as a separate component external to the controller 50.

The controller 50 calculates the power storage amount (remaining capacity) of the assembled battery 10 based on the voltage information output from the voltage sensors 40A to 40N and the electric-current information output from the electric-current sensor 61. Upon sensing turn-on of the ignition switch 51, the controller 50 starts the diagnosis mode in which the high-rate degradation state of the assembled battery 10 is diagnosed. The controller 50 controls the charge and discharge operation of the assembled battery 10.

The controller 50 has an internal timer 50B. The controller 50 controls the start and stop of counting operation of the internal timer 50B and measures the counting time from the start to stop of the counting operation. The timer 50B may be provided as a separate component external to the controller 50.

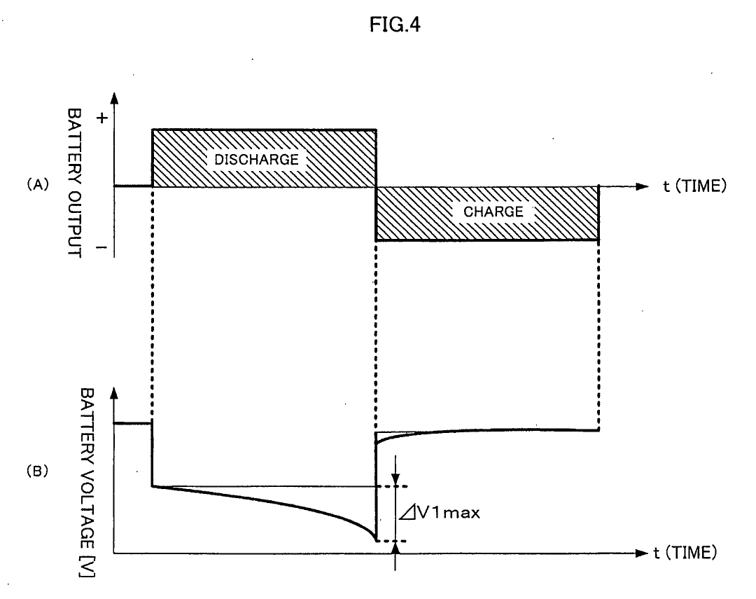

In the embodiment, the diagnosis mode of the assembled battery 10 is performed immediately after the ignition switch 51 is turned on. In the diagnosis mode, charge and discharge processing is performed in which the assembled battery 10 is successively discharged and charged at a constant power over a predetermined time period, and the degradation state of the assembled battery 10 is determined on the basis of the degree of the voltage change in the charge and discharge. FIG. 4 shows a power characteristic diagram (A) showing the output from the cells 11 when the diagnosis mode is performed, and a voltage characteristic diagram (B) showing the voltage change of the cells 11 when the diagnosis mode is performed. The output values of the cells 11 in the discharge and the input values of the cell 11 in the charge are the same and constant. The discharge time and the charge time are also the same.

For the “constant power” and the “predetermined time period”, it is necessary to set values such that discharge of the cell 11 reaching the high-rate degradation leads to a voltage drop which exceeds the threshold value. The threshold value is stored in the internal memory 50A of the controller 50. For example, in FIG. 2, it is possible that the states shown by the curves II and III representing smaller voltage drop amounts are determined as not reaching the high-rate degradation and that the state shown by the curve IV representing a larger voltage drop amount is determined as reaching the high-rate degradation.

The present invention is characterized in that it is found out that, when the lithium-ion battery reaching the high-rate degradation is discharged or charged at the constant power over the predetermined time period, the voltage drops or increases. Since specific numerical values of the “constant power,” “predetermined time period,” and “threshold value” are setting conditions which vary with vehicle models, sales regions and the like, detailed description thereof is omitted.

The phenomenon in which the voltage drops due to the high-rate degradation depends on the battery temperature and the power storage amount (remaining capacity) of the cell 11. It is thus desirable that the “constant power” and “predetermined time period” are experimentally obtained in accordance with the battery temperature and the power storage amount and are stored as a data table in the internal memory 50A.

By performing the diagnosis mode, the following can be determined relating to the degradation state of the assembled battery 10. As shown in FIG. 4, when the voltage drops during the discharge in the diagnosis mode, it can be seen that the assembled battery 10 is degraded. In addition, the degree of the voltage drop can be investigated to examine the extent of the degradation of the assembled battery 10.

A voltage drop amount at the end of the discharge, that is, ΔV1_{MAX} can be used as information indicating the degree of the voltage drop. In this case, the controller 50 calculates ΔV1_{MAX} of the battery block showing the largest voltage drop amount based on the voltage information output from the voltage sensors 40A to 40N to determine the degree of the voltage drop.

Specifically, the controller 50 compares the threshold value (value corresponding to voltage drop) read from the internal memory 50A with calculated value ΔV1_{MAX}, and determines that the assembled battery 10 is high-rate degraded when the threshold value is equal to or smaller than ΔV1_{MAX}, or determines that the assembled battery 10 is not high-rate degraded when the threshold value is larger than ΔV1_{MAX}.

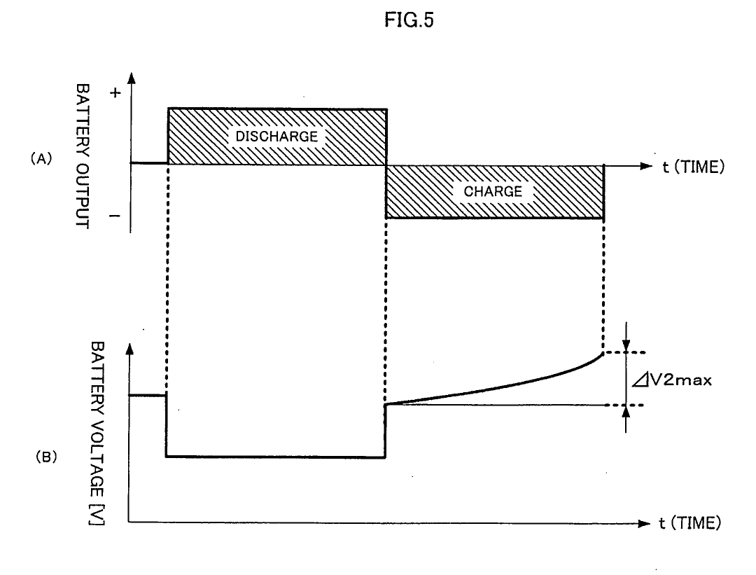

FIG. 5 shows a power characteristic diagram (A) showing the output from the cell 11 when the diagnosis mode is performed, and a voltage characteristic diagram (B) showing the voltage change of the cell 11 when the diagnosis mode is performed. The voltage characteristic diagram (B) in FIG. 5 represents different changes from that in FIG. 4. The output values of the cells 11 in the discharge and the input values of the cells 11 in the charge are the same and constant. The discharge time and the charge time are also the same.

As shown in FIG. 5, when the voltage increases during the charge in the diagnosis mode, it can be seen that the assembled battery 10 is degraded. In addition, the degree of the voltage increase can be investigated to examine the extent of the degradation of the assembled battery 10.

A voltage increase amount at the end of the charge, that is, ΔV2_{MAX} can be used as information indicating the degree of the voltage increase. In this case, the controller 50 calculates ΔV2_{MAX} of the battery block showing the largest voltage increase amount based on the voltage information output from the voltage sensors 40A to 40N to determine the degree of the voltage increase.

Specifically, the controller 50 compares the threshold value (value corresponding to voltage increase) read from the internal memory 50A with calculated value ΔV2_{MAX}, and determines that the assembled battery 10 is high-rate degraded when the threshold value is equal to or smaller than ΔV2_{MAX}, or determines that the assembled battery 10 is not high-rate degraded when the threshold value is larger than ΔV2_{MAX}.

When the assembled battery 10 is degraded in the discharge, the controller 50 performs processing of decreasing the upper limit value of electric current of the assembled battery 10, which is a reference value used in the control of discharge. This can lower the output from the assembled battery 10 to reduce (or eliminate) the voltage drop amount, for example when high output is required (this corresponds to the case where the vehicle is run at a high speed, by way of example). Thus, degradation of the assembled battery 10 can be suppressed.

When the assembled battery 10 is degraded in the charge, the controller 50 performs processing of decreasing the upper limit value of electric current of the assembled battery 10, which is a reference value used in the control of charge. This can lower the input to the assembled battery 10 to reduce (or eliminate) the voltage increase amount, for example when the input to the assembled battery 10 is high (this corresponds to the case where the vehicle is run on a downhill at a high speed over a predetermined time period and a large amount of regenerative energy can be recovered). Thus, degradation of the assembled battery 10 can be suppressed.

When the assembled battery 10 is degraded in both of the discharge side and charge side, both of the output to and input from the assembled battery 10 are lowered.

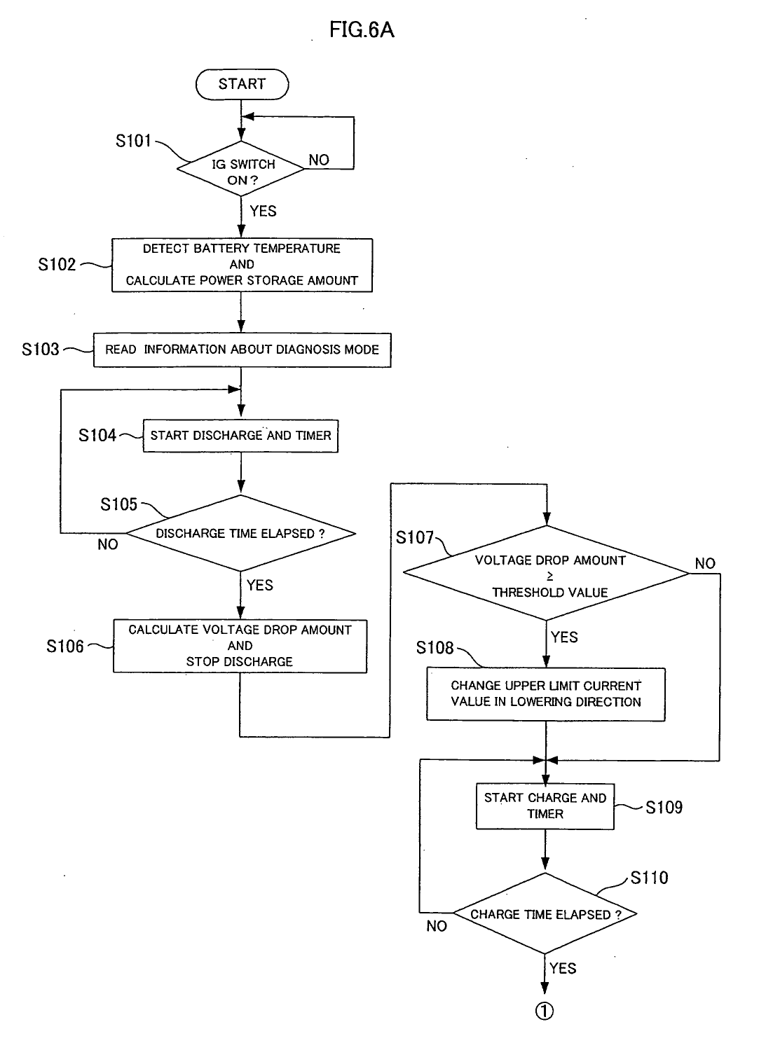

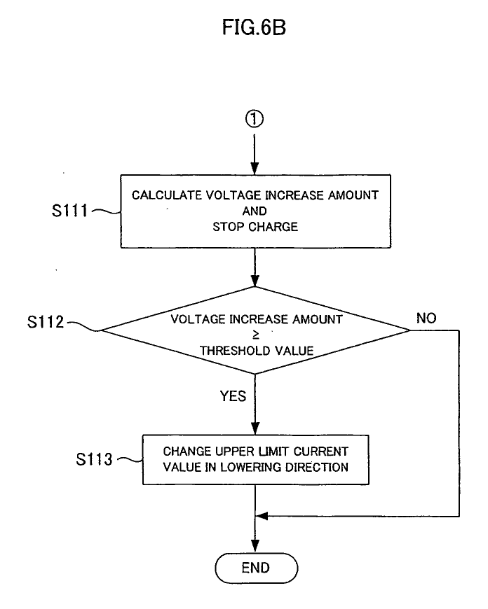

Next, the method of diagnosing the assembled battery 10 will be described in detail with reference to a flow chart of FIGS. 6A and 6B. The following flow chart is performed by the controller 50. At step S101, it is determined whether the ignition switch 51 is turned on or not. When it is determined that the ignition switch 51 is turned on, the flow proceeds to step S102.

At step S102, the battery temperature of the assembled battery 10 is detected on the basis of the temperature information output from the temperature sensor 60. In addition, the power storage amount (remaining capacity) of the assembled battery 10 is calculated on the basis of the information output from the electric-current sensor 61 and the voltage sensors 40A to 40N. Then, the flow proceeds to step S103.

At step S103, the information about the diagnosis mode (mode in which charge and discharge are forcedly performed at the constant power over the predetermined time period) is read from the internal memory 50A in accordance with the battery temperature and the power storage amount detected and calculated at step S102. Specifically, the information about the power value during discharge, the discharge time, the power value during charge, and the charge time is read from the internal memory 50A. Then, the flow proceeds to step S104.

At step S104, the discharge operation of the assembled battery 10 is started and the internal timer 50B is started. The power discharged from the assembled battery 10 can be used as the operating power for electric devices mounted on the vehicle. For example, when an air conditioner is operated during the discharge, the power discharged from the assembled battery 10 can be used as the operating power for the air conditioner. Therefore, the power produced during the diagnosis of the assembled battery 10 can be utilized effectively.

At step S105, it is determined whether or not the time counted by the internal timer 50B reaches the discharge time read at step S103. If it reaches the discharge time, the flow proceeds to step S106. If it does not reach the discharge time, the flow returns to step S104 to continue the discharge operation of the assembled battery 10 and the counting operation of the internal timer 50B.

At step S106, the voltage values of the battery blocks 12A to 12N are calculated on the basis of the voltage information output from the voltage sensors 40A to 40N, and the voltage drop amount ΔV1_{MAX} of the battery block with the largest voltage drop amount is calculated. In addition, at step S106, the discharge operation of the assembled battery 10 is stopped.

At step S107, the voltage drop amount ΔV1_{MAX} calculated at step S106 is compared with the threshold value read from the internal memory 50A. If ΔV1_{MAX} is equal to or larger than the threshold value, the flow proceeds to step S108. If ΔV1_{MAX} is smaller than the threshold value, the flow proceeds to step S109.

At step S108, the upper limit value of electric current of the assembled battery 10 is changed in lowering direction. This can reduce the upper limit of electric current discharged from the assembled battery 10 to reduce or eliminate the voltage drop amount in the cell 11. As a result, the voltage drop of the assembled battery 10 is suppressed to prevent shortening of the life of the assembled battery 10.

At step S109, the charge operation of the assembled battery 10 is started and the internal timer 50B is started. The electric current put into the assembled battery 10 can be obtained, for example, by driving the motor 30 with an engine, not shown.

At step S110, it is determined whether or not the time counted by the internal timer 508 reaches the charge time read at step S103. If it reaches the charge time, the flow proceeds to step S111. If it does not reach the charge time, the flow returns to step S109 to continue the charge operation of the assembled battery 10 and the counting operation of the internal timer 50B.

At step S111, the voltage values of the battery blocks 12A to 12N are calculated on the basis of the voltage information output from the voltage sensors 40A to 40N, and the voltage increase amount ΔV2_{MAX} of the battery block showing the largest voltage increase amount is calculated. In addition, at step S111, the charge operation of the assembled battery 10 is stopped.

At step S112, the voltage increase amount ΔV2_{MAX} calculated at step S111 is compared with the threshold value read from the internal memory 50A. If ΔV2_{MAX} is equal to or larger than the threshold value, the flow proceeds to step S113. If ΔV2_{MAX} is smaller than the threshold value, the flow is terminated.

At step S113, the upper limit value of electric current of the assembled battery 10 is changed in lowering direction. This can reduce the upper limit of electric current in the charge of the assembled battery 10 to reduce or eliminate the voltage increase amount in the cell 11. As a result, the voltage increase of the assembled battery 10 is suppressed to prevent shortening of the life of the assembled battery 10.

### Other Embodiments

It is also possible to use an integral (information about the voltage change) obtained by integrating the voltage drop amount during the discharge with respect to time, that is, ∫ΔV1dt, as the information indicating the degree of the voltage drop. In this case, the controller 50 calculates ∫ΔV1dt of the voltage block showing the largest voltage drop amount based on the voltage information output from the voltage sensors 40A to 40N to determine the degree of the voltage drop. Specifically, the controller 50 compares a threshold value (different from the threshold value in the abovementioned embodiment) read from the internal memory 50A with ∫ΔV1dt, and determines that the assembled battery 10 is high-rate degraded when ∫ΔV1dt is equal to or larger than the threshold value, or determines that the assembled battery 10 is not high-rate degraded when ∫ΔV1dt is smaller than the threshold value.

It is also possible to use an integral (information about the voltage change) obtained by integrating the voltage increase amount during the charge with respect to time, that is, ∫ΔV2dt, as the information indicating the degree of the voltage increase. In this case, the controller 50 calculates ∫ΔV2dt of the voltage block showing the largest voltage increase amount based on the voltage information output from the voltage sensors 40A to 40N to determine the degree of the voltage increase. Specifically, the controller 50 compares a threshold value (different from the threshold value in the abovementioned embodiment) read from the internal memory 50A with ∫ΔV2dt, and determines that the assembled battery 10 is high-rate degraded when ∫ΔV2dt is equal to or larger than the threshold value, or determines that the assembled battery 10 is not high-rate degraded when ∫ΔV2dt is smaller than the threshold value.

What is claimed is:

1. A degradation determination method for a lithium-ion battery, comprising:
determining a degradation state of the lithium-ion battery based on information about a voltage change in the lithium-ion battery obtained in a diagnosis mode in which the lithium-ion battery is successively charged and discharged at a constant power value.

2. The degradation determination method according to claim 1, wherein the constant power value in the diagnosis mode varies with a power storage amount and a temperature of the lithium-ion battery.

3. The degradation determination method according to claim 1, wherein the information is the degree of a voltage drop in the lithium-ion battery obtained during the discharge.

4. A control method for a lithium-ion battery, comprising:
performing the degradation determination method according to claim 3; and
changing an upper limit value of electric current in lowering direction, when it is determined that the degree of the voltage drop is equal to or more than a threshold value in the degradation determination method, the upper limit value being set as a maximum value of electric current output from the lithium-ion battery.

5. The degradation determination method according to claim 1, wherein the information is the degree of a voltage increase in the lithium-ion battery obtained during the charge.

6. A control method for a lithium-ion battery, comprising:
performing the degradation determination method according to claim 5; and
changing an upper limit value of electric current in lowering direction, when it is determined that the degree of the voltage increase is equal to or more than a threshold value in the degradation determination method, the upper limit value being set as a maximum value of electric current input to the lithium-ion battery.

7. A degradation determination apparatus for a lithium-ion battery, determining a degradation state of the lithium-ion battery, comprising:
an obtaining section which obtains information about a voltage of the lithium-ion battery; and
a determining section which determines the degradation state of the lithium-ion battery based on the information obtained by the obtaining section in a diagnosis mode in which the lithium-ion battery is successively charged and discharged at a constant power value.

8. The degradation determination apparatus according to claim 7, wherein the constant power value in the diagnosis mode varies with a power storage amount and a temperature of the lithium-ion battery.

9. The degradation determination apparatus according to claim 7, wherein the information is the degree of a voltage drop in the lithium-ion battery obtained during the discharge.

10. A control apparatus of a lithium-ion battery, comprising:
the degradation determination apparatus according to claim 9; and
an electric-current control section which, when the determining section determines that the degree of the voltage drop is equal to or more than a threshold value, changes an upper limit value of electric current in lowering direction, the upper limit value being set as a maximum value of electric current output from the lithium-ion battery.

11. The degradation determination apparatus according to claim 7, wherein the information is the degree of a voltage increase in the lithium-ion battery obtained during the charge.

12. A control apparatus of a lithium-ion battery, comprising:
the degradation determination apparatus according to claim 11; and
an electric-current control section which, when the determining section determines that the degree of the voltage increase is equal to or more than a threshold value, changes an upper limit value of electric current in lowering direction, the upper limit value being set as a maximum value of electric current input to the lithium-ion battery.

13. A vehicle comprising:
the control apparatus according to claim 10 mounted on the vehicle; and
the lithium-ion battery.

14. A vehicle comprising:
the control apparatus according to claim 12 mounted on the vehicle; and
the lithium-ion battery.
